(19) United States
(12) Patent Application Publication
(10) Pub. No.: US 2018/0363676 A1
(43) Pub. Date: Dec. 20, 2018

(54) INLET PRE-SWIRL GAS TURBINE ENGINE

(71) Applicant: General Electric Company, Schenectady, NY (US)

(72) Inventors: Christopher James Kroger, West Chester, OH (US); Trevor Wayne Goerig, Cincinnati, OH (US); Tsuguji Nakano, West Chester, OH (US); Jeffrey Donald Clements, Mason, OH (US)

(21) Appl. No.: 15/625,291

(22) Filed: Jun. 16, 2017

(51) Int. Cl. F04D 29/54; F04D 25/04; F04D 29/52; F04D 27/00; F02K 3/06

(52) U.S. Cl. CPC F04D 29/542; F04D 25/045; F05D 2220/32; F04D 27/009; F02K 3/06; F04D 29/522

(57) ABSTRACT

A gas turbine engine includes a turbomachine and a fan rotatable by the turbomachine. The fan includes a plurality of fan blades. The gas turbine engine also includes an outer nacelle surrounding the plurality of fan blades and defining an nacelle inlet, the outer nacelle including an inner wall defining a plurality of openings located aft of the nacelle inlet and forward of the plurality of fan blades of the fan along an axial direction for providing a swirl airflow upstream of the plurality of fan blades of the fan at a swirl angle greater than zero relative to a radial direction.

### FIELD

The present subject matter relates generally to a gas turbine engine having one or more features for pre-swirling an airflow provided to a fan of the gas turbine engine during operation.

### BACKGROUND

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air using one or more fuel nozzles within the combustion section and burned to provide combustion gases. The combustion gases are routed from the combustion section to the turbine section. The flow of combustion gasses through the turbine section drives the turbine section and is then routed through the exhaust section, e.g., to atmosphere.

Typical gas turbine engines include a drive turbine within the turbine section that is configured to drive, e.g., a low pressure compressor of the compressor section and the fan. In order to operate the gas turbine engine more efficiently, it is desirable to operate the drive turbine at a relatively high rotational speed. However, rotation of the fan at relatively high rotational speeds can lead to inefficiencies, such inefficiencies stemming from, e.g., shock losses and flow separation of an airflow over fan blades of the fan.

Accordingly, certain gas turbine engines have been developed with reduction gearboxes that allow the fan to rotate slower than the drive turbine. However, certain gearboxes may add complication, weight, and expense to the gas turbine engine. Therefore, a gas turbine engine configured to allow the drive turbine to operate at relatively high and efficient rotational speeds, while minimizing corresponding inefficiencies with the fan would be useful.

### BRIEF DESCRIPTION

Aspects and advantages of the invention will be set forth in part in the following description, or may be obvious from the description, or may be learned through practice of the invention.

In one exemplary embodiment of the present disclosure, a gas turbine engine defining an axial direction and a radial direction is provided. The gas turbine engine includes a turbomachine and a fan rotatable by the turbomachine. The fan includes a plurality of fan blades. The gas turbine engine also includes an outer nacelle surrounding the plurality of fan blades and defining an nacelle inlet, the outer nacelle including an inner wall defining a plurality of openings located aft of the nacelle inlet and forward of the plurality of fan blades of the fan along the axial direction for providing a swirl airflow upstream of the plurality of fan blades of the fan at a swirl angle greater than zero relative to the radial direction.

In certain exemplary embodiments, the gas turbine engine further includes an air tube extending between an inlet and an outlet, wherein the outlet of the air tube is in airflow communication with one or more of the openings defined by the inner wall of the outer nacelle. For example, in certain exemplary embodiments, the inlet of the air tube is in airflow communication with a high pressure air source. For example, in certain exemplary embodiments the gas turbine engine further includes an air compressor, wherein the air compressor is an airflow communication with the air tube.

In certain exemplary embodiments the gas turbine engine further includes a plurality of airflow nozzles, each airflow nozzle positioned at one of the openings defined by the inner wall of the nacelle. For example, in certain exemplary embodiments the plurality of airflow nozzles are formed separately from the inner wall of the outer nacelle and attached to the inner wall of the outer nacelle. For example, in certain exemplary embodiments each of the plurality of airflow nozzles defines an airflow direction, the airflow direction being equal to the swirl angle. For example, in certain exemplary embodiments the swirl angle is between five degrees and thirty-five degrees.

In certain exemplary embodiments the turbomachine includes a drive turbine, wherein the fan is mechanically coupled to and rotatable with the drive turbine such that the fan is rotatable by the drive turbine at the same rotational speed as the drive turbine. For example, in certain exemplary embodiments the fan defines a fan pressure ratio less than 1.5 and a fan tip speed greater than 1,250 feet per second during operation of the gas turbine engine at a rated speed.

In certain exemplary embodiments the gas turbine engine further includes an airflow delivery system, the airflow delivery system, the outer nacelle, or both defining a plenum extending along a circumferential direction of the gas turbine engine and within the outer nacelle, the plenum providing the swirl airflow to the plurality of openings.

For example, in certain exemplary embodiments the airflow delivery system further includes a plurality of swirl features positioned at least partially within the plenum. For example, in certain exemplary embodiments the plurality of swirl features is a plurality of airfoils. For example, in certain exemplary embodiments the plurality of airfoils each define a reference line at a trailing edge, the reference line defining the swirl angle.

In an exemplary aspect of the present disclosure, a method is provided of operating a direct drive gas turbine engine including a turbomachine, a fan section, and an outer nacelle. The turbomachine includes a drive turbine, the fan section includes a fan, and the outer nacelle defines an inlet. The method includes rotating the fan of the gas turbine engine with the drive turbine of the turbomachine such that the fan rotates at an equal rotational speed as the drive turbine. The method also includes providing a swirl airflow at a swirl angle through an inner wall of the outer nacelle at a location forward of the fan of the fan section to pre-swirl a bulk airflow received through the inlet of the outer nacelle.

In certain exemplary aspects providing the swirl airflow at the swirl angle includes providing the swirl airflow through a plurality of openings defined by the inner wall of the outer nacelle.

In certain exemplary aspects the swirl angle is between about five degrees and about thirty-five degrees relative to a radial direction of the gas turbine engine.

In certain exemplary aspects the method further includes receiving the swirl airflow from a high pressure air source, and transferring the swirl airflow received from the high pressure air source to a plurality of airflow nozzles positioned at the inner wall of the outer nacelle at a location forward of the fan of the fan section.

In certain exemplary aspects rotating the fan of the gas turbine engine with the drive turbine includes rotating the fan of the gas turbine engine such that a fan blade of the fan defines a fan tip speed greater than 1,250 feet per second.

In certain exemplary aspects rotating the fan of the gas turbine engine with the drive turbine includes rotating the fan of the gas turbine engine such that the fan defines a fan pressure ratio less than 1.5.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a close-up, schematic, cross-sectional view of a forward end of the exemplary gas turbine engine of FIG. 1.

FIG. 3 is a schematic view of an inlet to the exemplary gas turbine engine of FIG. 1, along an axial direction of the gas turbine engine of FIG. 1.

FIG. 4 it is a schematic view of an inlet to a gas turbine engine in accordance with another exemplary embodiment of the present disclosure.

FIG. 5 is a cross-sectional view of a part span inlet guide vane of the exemplary gas turbine engine of FIG. 1 at a first location along a span of the part span inlet guide vane.

FIG. 6 is a cross-sectional view of the part span inlet guide vane of the exemplary gas turbine engine of FIG. 1 at a second location along the span of the part span inlet guide vane.

FIG. 7 is a close-up, schematic, cross-sectional view of a forward end of a gas turbine engine in accordance with still another exemplary embodiment of the present disclosure.

FIG. 8 is a close-up, schematic, cross-sectional view of a forward end of a gas turbine engine in accordance with yet another exemplary embodiment of the present disclosure.

FIG. 9 is a schematic, cross-sectional view of an outer nacelle of the exemplary gas turbine engine of FIG. 7, as viewed along Line 21-21 of FIG. 7.

FIG. 10 is a close-up view of an airflow nozzle of the exemplary turbine engine of FIG. 9.

FIG. 11 is a close-up view of an airflow nozzle in accordance with another exemplary embodiment of the present disclosure.

FIG. 12 is a close-up view of an airflow nozzle in accordance with yet another exemplary embodiment of the present disclosure.

FIG. 13 is a close-up, cross-sectional view of the exemplary airflow nozzle of FIG. 10.

FIG. 14 is a schematic, cross-sectional view of an outer nacelle and a portion of an airflow distribution system of a gas turbine engine accordance with another exemplary embodiment of the present disclosure.

FIG. 15 is a perspective view of a plurality of swirl features of the exemplary airflow distribution system of FIG. 26 in accordance with an exemplary embodiment of the present disclosure.

FIG. 16 is a flow diagram depicting a method for operating a gas turbine engine in accordance with an exemplary aspect of the present disclosure.

FIG. 17 is a flow diagram depicting a method for operating a gas turbine engine in accordance with another exemplary aspect of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a gas turbine engine, with forward referring to a position closer to an engine inlet and aft referring to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, in certain contexts, the approximating language may refer to being within a 10% margin.

Here and throughout the specification and claims, range limitations may be combined and interchanged, such that ranges identified include all the sub-ranges contained therein unless context or language indicates otherwise.

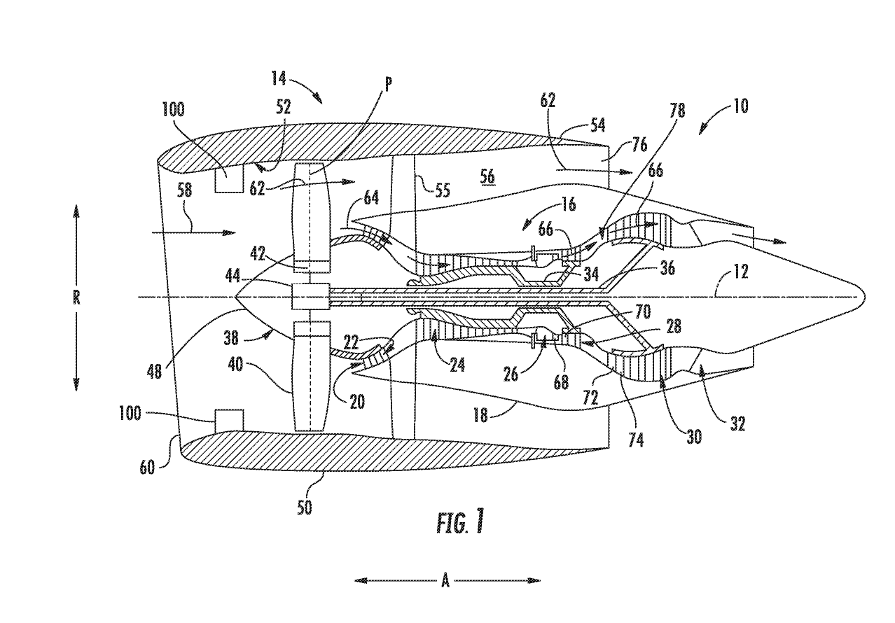

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (i.e., a direction extending about the axial direction A; see, e.g., FIG. 3). In general, the turbofan 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The LP turbine 30 may also be referred to as a “drive turbine”.

For the embodiment depicted, the fan section 14 includes a variable pitch fan 38 having a plurality of fan blades 40 coupled to a disk 42 in a spaced apart manner. More specifically, for the embodiment depicted, the fan section 14 includes a single stage fan 38, housing a single stage of fan blades 40. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan 38 is mechanically coupled to and rotatable with the LP turbine 30, or drive turbine. More specifically, the fan blades 40, disk 42, and actuation member 44 are together rotatable about the longitudinal axis 12 by LP shaft 36 in a “direct drive” configuration. Accordingly, the fan 38 is coupled with the LP turbine 30 in a manner such that the fan 38 is rotatable by the LP turbine 30 at the same rotational speed as the LP turbine 30.

Further, it will be appreciated that the fan 38 defines a fan pressure ratio and the plurality of fan blades 40 each define a fan tip speed. As will be described in greater detail below, the exemplary turbofan engine 10 depicted defines a relatively high fan tip speed and relatively low fan pressure ratio during operation of the turbofan engine at a rated speed. As used herein, the “fan pressure ratio” refers to a ratio of a pressure immediately downstream of the plurality of fan blades 40 during operation of the fan 38 to a pressure immediately upstream of the plurality of fan blades 40 during the operation of the fan 38. Also as used herein, the “fan tip speed” defined by the plurality of fan blades 40 refers to a linear speed of an outer tip of a fan blade 40 along the radial direction R during operation of the fan 38. Further, still, as used herein, the term “rated speed” refers to a maximum operating speed of the turbofan engine 10, in which the turbofan engine 10 generates a maximum amount of power.

Referring still to the exemplary embodiment of FIG. 1, the disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the plurality of fan blades 40 of the fan 38 and/or at least a portion of the turbomachine 16. More specifically, the nacelle 50 includes an inner wall 52 and a downstream section 54 of the inner wall 52 of the nacelle 50 extends over an outer portion of the turbomachine 16 so as to define a bypass airflow passage 56 therebetween. Additionally, for the embodiment depicted, the nacelle 50 is supported relative to the turbomachine 16 by a plurality of circumferentially spaced outlet guide vanes 55.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. For the embodiment depicted, the bypass ratio may generally be between about 7:1 and about 20:1, such as between about 10:1 and about 18:1. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary turbofan engine 10 depicted in FIG. 1 and described above is by way of example only, and that in other exemplary embodiments, the turbofan engine 10 may have any other suitable configuration. For example, in other exemplary embodiments, the turbomachine 16 may include any other suitable number of compressors, turbines, and/or shaft or spools. Additionally, the turbofan engine 10 may not include each of the features described herein, or alternatively, may include one or more features not described herein. For example, in other exemplary embodiments, the fan 38 may not be a variable pitch fan. Additionally, although described as a “turbofan” gas turbine engine, in other embodiments the gas turbine engine may instead be configured as any other suitable ducted gas turbine engine.

Referring still to FIG. 1, and as previously discussed, the exemplary turbofan engine 10 depicted in FIG. 1 is configured as a direct drive turbofan engine 10. In order to increase an efficiency of the turbomachine 16, the LP turbine 30 is configured to rotate at a relatively high rotational speed. Given the direct-drive configuration, such also causes the plurality of fan blades 40 of the fan 38 to rotate at a relatively high rotational speed. For example, during operation of the turbofan engine 10 at the rated speed, the fan tip speed of each of the plurality of fan blades 40 is greater than 1,250 feet per second. For example, in certain exemplary embodiments, during operation of the turbofan engine 10 at the rated speed, the fan tip speed of each of the plurality of fan blades 40 may be greater than about 1,350 feet per second, such as greater than about 1,450 feet per second, such as greater than about 1,550 feet per second, such as up to about 2,200 feet per second.

Despite these relatively fan tip speeds, the fan 38 is, nevertheless designed to define a relatively low fan pressure ratio. For example, during operation of the turbofan engine 10 at the rated speed, the fan pressure ratio of the fan 38 is less than 1.5. For example, during operation of the turbofan engine 10 at the rated speed, the fan pressure ratio may be between about 1.15 and about 1.5, such as between about 1.25 and about 1.4.

As will be appreciated, operating the direct drive turbofan engine 10 in such a manner may ordinarily lead to efficiency penalties of the fan 38 due to shock losses and flow separation of an airflow over the fan blades 40, especially at the radially outer tips of the plurality of fan blades 40 of the fan 38. Accordingly, as will be described in much greater detail below, the turbofan engine 10 may further include one or more inlet pre-swirl features upstream of the plurality of fan blades 40 of the fan 38 to offset or minimize such efficiency penalties of the fan 38. With the inclusion of such inlet pre-swirl features, the efficiency gains of the turbomachine 16 due to, e.g., increased rotational speeds of the LP turbine 30, outweigh the above identified potential efficiency penalties.

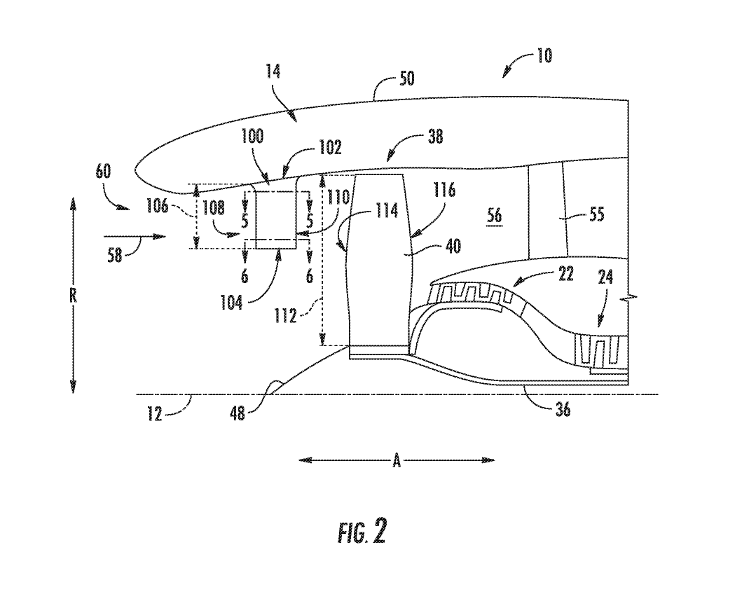

Referring now also to FIG. 2, a close-up, cross-sectional view of the fan section 14 and forward end of the turbomachine 16 of the exemplary turbofan engine 10 of FIG. 1 is provided. As stated, the turbofan engine 10 includes an inlet pre-swirl feature located upstream of the plurality of fan blades 40 of the fan 38 and attached to or integrated into the nacelle 50. More specifically, for the embodiment of FIGS. 1 and 2, the inlet pre-swirl feature is configured as a plurality of part span inlet guide vanes 100. The plurality of part span inlet guide vanes 100 are each cantilevered from of the outer nacelle 50 (such as from the inner wall 52 of the outer nacelle 50) at a location forward of the plurality of fan blades 40 of the fan 38 along the axial direction A and aft of the inlet 60 of the nacelle 50. More specifically, each of the plurality of part span inlet guide vanes 100 define an outer end 102 along the radial direction R, and are attached to/connected to the outer nacelle 50 at the radially outer end 102 through a suitable connection means (not shown). For example, each of the plurality of part span inlet guide vanes 100 may be bolted to the inner wall 52 of the outer nacelle 50 at the outer end 104, welded to the inner wall 52 of the outer nacelle 50 at the outer end 102, or attached to the outer nacelle 50 in any other suitable manner at the outer end 102.

Further, for the embodiment depicted, the plurality of part span inlet guide vanes 100 extend generally along the radial direction R from the outer end 102 to an inner end 104 (i.e., an inner end 104 along the radial direction R). Moreover, as will be appreciated, for the embodiment depicted, each of the plurality of part span inlet guide vanes 100 are unconnected with an adjacent part span inlet guide vane 100 at the respective inner ends 104 (i.e., adjacent part span inlet guide vanes 100 do not contact one another at the radially inner ends 104, and do not include any intermediate connection members at the radially inner ends 104, such as a connection ring, strut, etc.). More specifically, for the embodiment depicted, each part span inlet guide vane 100 is completely supported by a connection to the outer nacelle 50 at the respective outer end 102 (and not through any structure extending, e.g., between adjacent part span inlet guide vanes 100 at a location inward of the outer end 102 along the radial direction R). As will be discussed below, such may reduce an amount of turbulence generated by the part span inlet guide vanes 100.

Moreover, is depicted, each of the plurality of part span inlet guide vanes 100 do not extend completely between the outer nacelle 50 and, e.g., the hub 48 of the turbofan engine 10. More specifically, for the embodiment depicted, each of the plurality of inlet guide vane define an IGV span 106 along the radial direction R, and further each of the plurality of part span inlet guide vanes 100 further define a leading edge 108 and a trailing edge 110. The IGV span 106 refers to a measure along the radial direction R between the outer end 102 and the inner end 104 of the part span inlet guide vane 100 at the leading edge 108 of the part span inlet guide vane 100. Similarly, it will be appreciated, that the plurality of fan blades 40 of the fan 38 define a fan blade span 112 along the radial direction R. More specifically, each of the plurality of fan blades 40 of the fan 38 also defines a leading edge 114 and a trailing edge 116, and the IGV span 106 refers to a measure along the radial direction R between a radially outer tip and a base of the fan blade 40 at the leading edge 114 of the respective fan blade 40.

For the embodiment depicted, the IGV span 106 is at least about five percent of the fan blade span 112 and up to about fifty-five percent of the fan blade span 112. For example, in certain exemplary embodiments, the IGV span 106 may be between about fifteen percent of the fan blade span 112 and about forty-five percent of the fan blade span 112, such as between about thirty percent of the fan blade span 112 and about forty percent of the fan blade span 112.

Reference will now also be made to FIG. 3, providing an axial view of the inlet 60 to the turbofan engine 10 of FIGS. 1 and 2. As will be appreciated, for the embodiment depicted, the plurality of part span inlet guide vanes 100 of the turbofan engine 10 includes a relatively large number of part span inlet guide vanes 100. More specifically, for the embodiment depicted, the plurality of part span inlet guide vanes 100 includes between about twenty part span inlet guide vanes 100 and about fifty part span inlet guide vanes 100. More specifically, for the embodiment depicted, the plurality of part span inlet guide vanes 100 includes between about thirty part span inlet guide vanes 100 and about forty-five part span inlet guide vanes 100, and more specifically, still, the embodiment depicted includes thirty-two part span inlet guide vanes 100. Additionally, for the embodiment depicted, each of the plurality of part span inlet guide vanes 100 are spaced substantially evenly along the circumferential direction C. More specifically, each of the plurality of part span inlet guide vanes 100 defines a circumferential spacing 118 with an adjacent part span inlet guide vane 100, with the circumferential spacing 118 being substantially equal between each adjacent part span inlet guide vane 100.

Although not depicted, in certain exemplary embodiments, the number of part span inlet guide vanes 100 may be substantially equal to the number of fan blades 40 of the fan 38 of the turbofan engine 10. In other embodiments, however, the number of part span inlet guide vanes 100 may be greater than the number of fan blades 40 of the fan 38 of the turbofan engine 10, or alternatively, may be less than the number of fan blades 40 of the fan 38 of the turbofan engine 10.

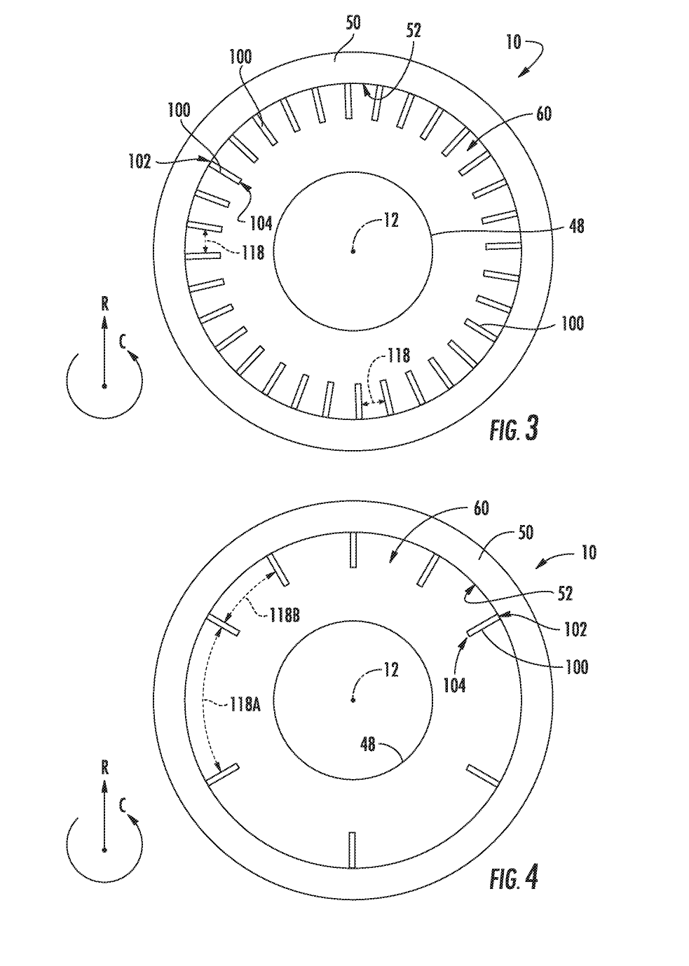

Further, should be appreciated, that in other exemplary embodiments, the turbofan engine 10 may include any other suitable number of part span inlet guide vanes 100 and/or circumferential spacing 118 of the part span inlet guide vanes 100. For example, referring now briefly to FIG. 4, an axial view of an inlet 60 to a turbofan engine 10 in accordance with another exemplary embodiment of the present disclosure is provided. For the embodiment of FIG. 4, the turbofan engine 10 includes less than twenty part span inlet guide vanes 100. More specifically, for the embodiment of FIG. 4, the turbofan engine 10 includes at least eight part span inlet guide vanes 100, or more specifically includes exactly eight part span inlet guide vanes 100. Additionally, for the embodiment of FIG. 4, the plurality of part span inlet guide vanes 100 are not substantially evenly spaced along the circumferential direction C. For example, at least certain of the plurality of part span inlet guide vanes 100 define a first circumferential spacing 118A, while other of the plurality of part span inlet guide vanes 100 define a second circumferential spacing 118B. For the embodiment depicted, the first circumferential spacing 118A is at least about twenty percent greater than the second circumferential spacing 118B, such as at least about twenty-five percent greater such as at least about thirty percent greater, such as up to about two hundred percent greater. Notably, as will be described in greater detail below, the circumferential spacing 118 refers to a mean circumferential spacing between adjacent part span inlet guide vanes 100. The non-uniform circumferential spacing may, e.g., offset structure upstream of the part span inlet guide vanes 100.

Referring now back to the embodiment of FIG. 2, it will be appreciated that each of the plurality of part span inlet guide vanes 100 is configured to pre-swirl an airflow 58 provided through the inlet 60 of the nacelle 50, upstream of the plurality of fan blades 40 of the fan 38. As briefly discussed above, pre-swirling the airflow 58 provided through the inlet 60 of the nacelle 50 prior to such airflow 58 reaching the plurality of fan blades 40 of the fan 38 may reduce separation losses and/or shock losses, allowing the fan 38 to operate with the relatively high fan tip speeds described above with less losses of in efficiency.

For example, referring first to FIG. 5, a cross-sectional view of one part span inlet guide vane 100 along the span of the part span inlet guide vanes 100, as indicated by Line 5-5 in FIG. 2, is provided. As is depicted, the part span inlet guide vane 100 is configured generally as an airfoil having a pressure side 120 and an opposite suction side 122, and extending between the leading edge 108 and the trailing edge 110 along a camber line 124. Additionally, the part span inlet guide vane 100 defines a chord line 126 extending directly from the leading edge 108 to the trailing edge 110. The chord line 126 defines an angle of attack 128 with an airflow direction 129 of the airflow 58 through the inlet 60 of the nacelle 50. Notably, for the embodiment depicted, the airflow direction 129 is substantially parallel to the axial direction A of the turbofan engine 10. For the embodiment depicted, the angle of attack 128 at the location depicted along the span 106 of the part span inlet guide vanes 100 is at least about five degrees and up to about thirty-five degrees. For example, in certain embodiments, the angle of attack 128 at the location depicted along the span 106 of the part span inlet guide vane 100 may be between about ten degrees and about thirty degrees, such as between about fifteen degrees and about twenty-five degrees.

Additionally, the part span inlet guide vane 100, at the location depicted along the span 106 of the part span inlet guide vane 100 defines a local swirl angle 130 at the trailing edge 110. The “swirl angle” at the trailing edge 110 of the part span inlet guide vane 100, as used herein, refers to an angle between the airflow direction 129 of the airflow 58 through the inlet 60 of the nacelle 50 and a reference line 132 defined by a trailing edge section of the pressure side 120 of the part span inlet guide vane 100. More specifically, the reference line 132 is defined by the aft twenty percent of the pressure side 120, as measured along the chord line 126. Notably, when the aft twenty percent the pressure side 120 defines a curve, the reference line 132 may be straight-line average fit of such curve (e.g., using least mean squares).

Further, it will be appreciated, that a maximum swirl angle 130 refers to the highest swirl angle 130 along the span 106 of the part span inlet guide vane 100. For the embodiment depicted, the maximum swirl angle 130 is defined proximate the radially outer end 102 of the part span inlet guide vane 100 (e.g., at the outer ten percent of the span 106 of the part span inlet guide vanes 100), as is represented by the cross-section depicted in FIG. 5. For the embodiment depicted, the maximum swirl angle 130 of each part span inlet guide vane 100 at the trailing edge 110 is between five degrees and thirty-five degrees. For example, in certain exemplary embodiments, the maximum swirl angle 130 of each part span inlet guide vane 100 at the trailing edge 110 may be between twelve degrees and twenty-five degrees.

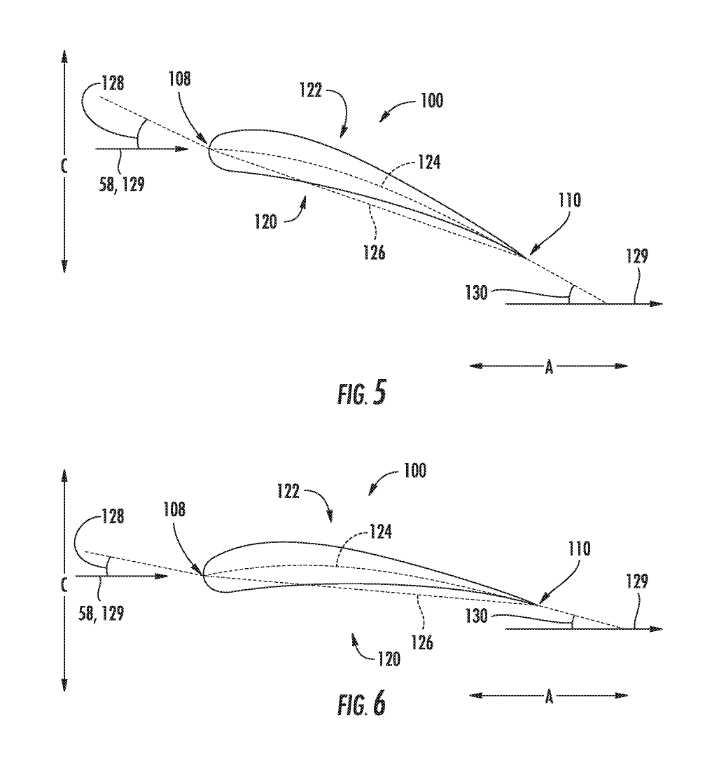

Moreover, it should be appreciated that for the embodiment of FIG. 2, the local swirl angle 130 increases from the radially inner end 104 to the radially outer end 102 of each part span inlet guide vane 100. For example, referring now also to FIG. 6, a cross-sectional view of a part span inlet guide vane 100 at a location radially inward from the cross-section viewed in FIG. 5, as indicated by Line 6-6 in FIG. 2, is provided. As is depicted in FIG. 6, and as stated above, the part span inlet guide vane 100 defines the pressure side 120, the suction side 122, the leading edge 108, the trailing edge 110, the camber line 124, and chord line 126. Further, the angle of attack 128 defined by the chord line 126 and the airflow direction 129 of the airflow 58 through the inlet 60 of the nacelle 50 at the location along the span 106 depicted in FIG. 6 is less than the angle of attack 128 at the location along the span 106 depicted in FIG. 5 (e.g., may be at least about twenty percent less, such as at least about fifty percent less, such as up to about one hundred percent less). Additionally, the part span inlet guide vane 100 defines a local swirl angle 130 at the trailing edge 110 at the location along the span 106 of the part span inlet guide vane 100 proximate the inner end 104, as depicted in FIG. 6. As stated above, the local swirl angle 130 increases from the radially inner end 104 to the radially outer end 102 of each part span inlet guide vanes 100. Accordingly, the local swirl angle 130 proximate the outer end 102 (see FIG. 5) is greater than the local swirl angle 130 proximate the radially inner end 104 (see FIG. 6; e.g., the radially inner ten percent of the span 106). For example, the local swirl angle 130 may approach zero degrees (e.g., may be less than about five degrees, such as less than about two degrees) at the radially inner end 104.

Notably, including part span inlet guide vanes 100 of such a configuration may reduce an amount of turbulence at the radially inner end 104 of each respective part span inlet guide vane 100. Additionally, such a configuration may provide a desired amount of pre-swirl at the radially outer ends of the plurality of fan blades 40 of the fan 38 (where the speed of the fan blades 40 is the greatest) to provide a desired reduction in flow separation and/or shock losses that may otherwise occur due to a relatively high speed of the plurality of fan blades 40 at the fan tips during operation of the turbofan engine 10.

Referring generally to FIGS. 2, 3, 5, and 6, it will be appreciated that for the embodiment depicted, the plurality of part span inlet guide vanes 100 further define a solidity. The solidity is defined generally as a ratio of a chord length (i.e., a length of the chord line 126) of each part span inlet guide vane 100 to a circumferential spacing 118 of the plurality of part span inlet guide vanes 100. More specifically, for the purposes of defining the solidity, the circumferential spacing 118 refers to the mean circumferential spacing 118 calculated using the following equation:

2×π×rₘ²÷n_{b} (Equation 1);

wherein rₘ is the mean radius of the plurality of part span inlet guide vanes 100 and n_{b} is the number of part span inlet guide vanes 100. The mean radius, rₘ, may refer to a position halfway along the IGV span 106, relative to the longitudinal centerline 12 of the turbofan engine 10. Notably, for the purposes of calculating solidity, the chord length refers to the chord length at the mean radius, rₘ. For the embodiment depicted, the solidity is between about 0.5 and is about 1.5. For example, in certain exemplary embodiments, the solidity of the part span inlet guide vanes 100 may be between about 0.7 and 1.2, such as between about 0.9 and about 1.0. Such a configuration may ensure desired amount of pre-swirl during operation of the turbofan engine 10.

Notably, the plurality of part span inlet guide vanes 100 depicted in FIGS. 1 through 6 are generally configured to pre-swirl a portion of an airflow through the inlet 60 of the outer nacelle 50 in a rotational direction that is the same as a rotational direction of the plurality of fan blades 40 of the fan 38. For example, for the exemplary embodiment of FIGS. 1 through 6, the plurality of fan blades 40 of the fan 38 are configured to rotate clockwise when viewed forward looking aft and the plurality of part-span inlet guide vanes 100 (and other pre-swirl features discussed herein) are configured to pre-swirl a portion of the airflow through the inlet 60 of the outer nacelle 50 in the same direction. However, in other exemplary embodiments the gas turbine engine may include a fan 38 with fan blades 40 configured to rotate counter-clockwise when viewed forward looking aft, in which case the plurality of part-span inlet guide vanes 100 (or other pre-swirl features discussed herein) may instead be mirrored such that they are configured to pre-swirl airflow in an opposite rotational direction than the direction depicted. Further, in still other exemplary embodiments, the plurality of part-span inlet guide vanes 100 (or other pre-swirl features discussed herein) may be configured to pre-swirl an airflow in an opposite rotational direction as the plurality of fan blades 40 of the fan 38.

Additionally, it should be appreciated that the exemplary part span inlet guide vanes 100 depicted in FIGS. 1 through 6 are provided by way of example only. In other exemplary embodiments, the plurality of part span inlet guide vanes 100 may have any other suitable configuration for providing a desired amount of pre-swirl upstream of a plurality of fan blades 40 of a fan 38 of a gas turbine engine.

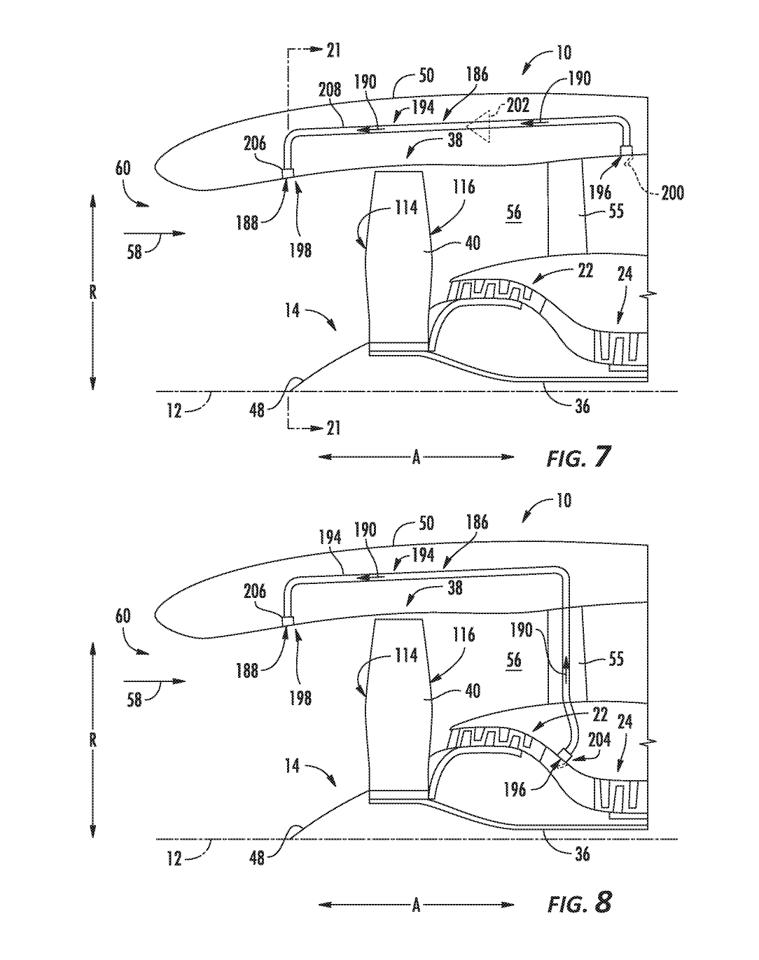

It should further be appreciated that in still other embodiments of the present disclosure any other suitable inlet pre-swirl feature may be provided located upstream of the plurality of fan blades 40 of the fan 38 of the gas turbine engine. For example, referring now to FIG. 7, an inlet pre-swirl feature in accordance with yet another exemplary embodiment of the present disclosure is provided. More specifically, FIG. 7 depicts a turbofan engine 10 in accordance with an embodiment of the present disclosure, configured in substantially the same manner as the exemplary turbofan engine 10 described above with reference to FIGS. 1 and 2. Accordingly, the exemplary turbofan engine 10 of FIG. 7 generally includes a turbomachine 16 and a fan section 14. The turbomachine 16 includes a compressor section and, although not depicted, a turbine section having a drive turbine, or LP turbine 30 (see FIG. 1), mechanically coupled to a fan 38 of the fan section 14 through, for the embodiment depicted, an LP shaft 36. Additionally, the fan 38 includes a plurality of fan blades 40 rotatable about a longitudinal centerline 12 of the turbomachine 16. The plurality of fan blades 40 of the fan 38 are surrounded by, and enclosed by, an outer nacelle 50 of the turbofan engine 10, the outer nacelle 50 including an inner wall 52. Downstream of the fan 38 of the fan section 14, the outer nacelle 50 defines a bypass airflow passage 56 with the turbomachine 16. Further, the exemplary turbofan engine 10 includes an inlet pre-swirl feature attached to or integrated with the inner wall 52 of the outer nacelle 50 at a location forward of the plurality of fan blades 40 of the fan 38.

However, for the embodiment of FIG. 7, the inlet pre-swirl feature does not include a plurality of part span inlet guide vanes 100, and instead is configured as an airflow delivery system 186. More specifically, for the embodiment of FIG. 7 the inner wall 52 of the outer nacelle 50 defines a plurality of openings 188 located forward of the plurality of fan blades 40 of the fan 38 along the axial direction A. The inlet pre-swirl feature includes these plurality of openings 188, with the plurality of openings 188 configured to provide a swirl airflow 190 upstream of the plurality of fan blades 40 of the fan 38 at a swirl angle 192 greater than zero relative to the radial direction R of the turbofan engine 10 (and more specifically relative to a local reference plane defined by the axial direction A and the radial direction R). As is depicted, for the embodiment of FIG. 7 the airflow delivery system 186 generally includes an air tube 194 extending between an inlet 196 and an outlet 198. As will be discussed in greater detail below, the outlet 198 of the air tube 194 is in airflow communication with the plurality of openings 188 defined by the inner wall 52 of the outer nacelle 50. Additionally, the inlet 196 of the air tube 194 is in airflow communication with a high pressure air source for receiving the swirl airflow 190. For the embodiment depicted, the high pressure air source is the bypass airflow passage 56 at a location downstream of the plurality of fan blades 40 the fan 38.

As is depicted in phantom, in certain embodiments, the airflow delivery system 186 may further include a door 200 (i.e., a door, scoop, or other structural component) to scoop air into the inlet 196 of the air tube 194. The door 200 may be movable between an open position and closed position depending on, e.g., an operating condition of the gas turbine engine. For example, the door 200 may move to the open position when it is desirable to provide pre-swirling of an airflow 58 through the inlet 60 of the outer nacelle 50. As is also depicted in phantom, the airflow delivery system 186 may further include an air compressor 202, the air compressor 202 in airflow communication with the air tube 194. The air compressor 202 may act to increase a pressure of the swirl airflow 190 through the air tube 194 to increase an amount of, e.g., pre-swirl provided by the inlet pre-swirl feature depicted.

Notably, however, in other exemplary embodiments any other suitable high pressure air source may be provided. For example, referring now to FIG. 8, a cross-sectional view of a gas turbine engine in accordance with another exemplary embodiment of the present disclosure is provided. The exemplary gas turbine engine of FIG. 8 is configured in substantially the same manner as the exemplary turbofan engine 10 described above with reference to FIG. 7. However, for the embodiment of FIG. 8, the air tube 194 of the airflow delivery system 186 is in airflow communication with a different high pressure air source. More specifically, for the embodiment of FIG. 8, the high pressure air source is a compressor of the compressor section of the turbomachine 16. More specifically, still, for the embodiment of FIG. 8, the high pressure air source is a compressor bleed valve 204 of the compressor section of the turbofan engine 10. However, in still other exemplary embodiments, any other suitable high pressure air source may be provided.

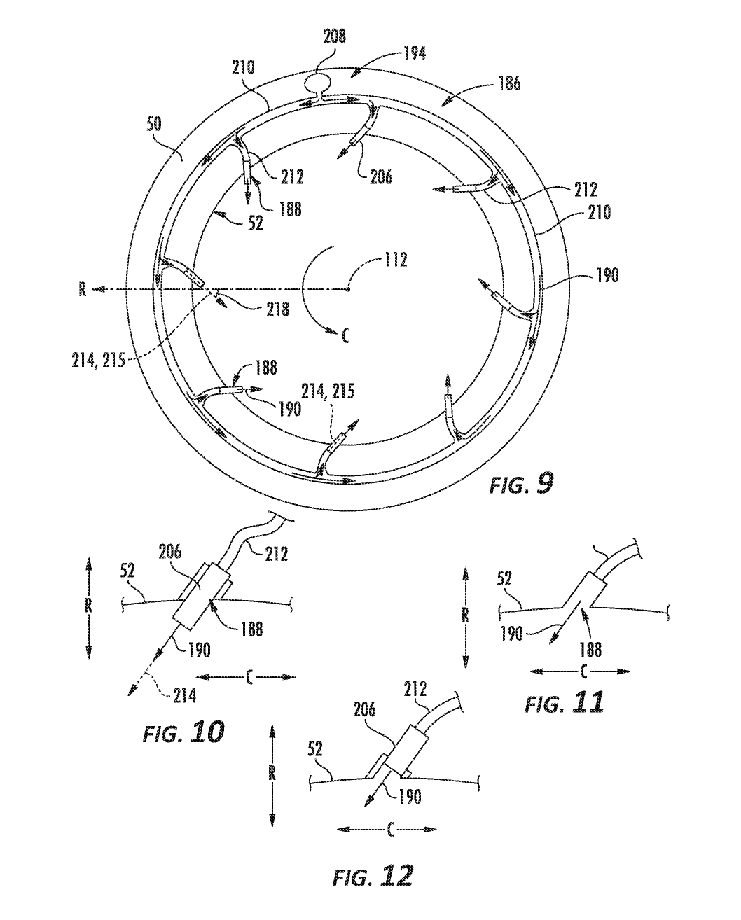

Referring back to FIG. 7, the turbofan engine 10, or rather the airflow delivery system 186 of the turbofan engine 10, further includes a plurality of airflow nozzles 206, with each airflow nozzle 206 positioned at one of the openings 188 defined by the inner wall 52 of the nacelle 50. Referring now also to FIG. 9, a cross-sectional view of a section of the outer nacelle 50 defining the openings 188 and including the airflow nozzles 206 is provided along Line 21-21 of FIG. 7. As is depicted, the air tube 194 of the airflow delivery system 186 further includes a plurality of segments. For example, in the embodiment depicted, the air tube 194 includes a supply air tube 208 in airflow communication with the inlet 196 for receiving the swirl airflow 190 from the high pressure air source. Additionally, the air tube 194 includes a distribution air tube 210 extending from the supply air tube 208 and, for the embodiment depicted, in the circumferential direction C substantially three hundred sixty degrees within the outer nacelle 50. Further, the air tube 194 includes a plurality of extension air tubes 212 extending between the distribution air tube 210 and the plurality of airflow nozzles 206, with each of the extension air tubes 212 defining a respective outlet 198 of the air tube 194. Accordingly, with such an embodiment, the air tube 194 further defines a plurality of outlets 198.

As is depicted, the airflow nozzles 206 each define an airflow direction 214, the airflow direction 214 being the direction in which the swirl airflow 190 is provided through the openings 188 of the inner wall 52 of the outer nacelle 50. In certain exemplary embodiments, the airflow direction 214 of each of the respective airflow nozzles 206 may extend along a centerline 215 of each of the respective airflow nozzles 206. Additionally, for the embodiment depicted the airflow direction 214 defines the swirl angle 192. Accordingly, for the embodiment depicted, the swirl angle 192 may refer to an angle between the airflow direction 214 of the plurality of airflow nozzles 206 and the radial direction R of the turbofan engine 10, or more specifically, for the embodiment depicted, the swirl angle 192 refers to an angle between the airflow direction 214 and a reference plane defined by the radial direction R and the axial direction A of the turbofan engine 10. In certain exemplary embodiments, the swirl angle 192 is between five degrees and thirty-five degrees. For example, in certain embodiments the swirl angle 192 may be between ten degrees and thirty degrees, such as between fifteen degrees and twenty-five degrees.

Further, the plurality of airflow nozzles 206 may include any suitable number of airflow nozzles 206, such as between about five airflow nozzles 206 and about one hundred airflow nozzles 206. More specifically, for the embodiment depicted, the plurality of airflow nozzles 206 includes eight airflow nozzles 206. However, in other embodiments, the turbofan engine 10 of FIG. 9 may include the same number of airflow nozzles 206 as, e.g., the exemplary turbofan engine 10 described above with reference to FIGS. 1 through 3 includes part span inlet guide vanes 100. For example, in certain exemplary embodiments, the turbofan engine 10 may include at least twenty airflow nozzles 206, such as at least thirty airflow nozzles 206, and up to about fifty airflow nozzles 206, such as up to about forty-five airflow nozzles 206.

Referring now briefly to FIG. 10, providing a close-up view of one of the exemplary airflow nozzles 206, it will be appreciated that for the embodiment depicted, the plurality of airflow nozzles 206 are formed separately from the inner wall 52 of the outer nacelle 50 and attached to the inner wall 52 of the outer nacelle 50. Additionally, for the embodiment depicted, the plurality of airflow nozzles 206 each extend through a respective opening 188 in the inner wall 52 of the outer nacelle 50. It should be appreciated, however, that in other exemplary embodiments, any other suitable configuration of airflow nozzles 206 may be provided. For example, referring briefly to FIG. 11, in other exemplary embodiments, one or more of the plurality of airflow nozzles 206 may be formed integrally with the inner wall 52 of the outer nacelle 50 (e.g., by casting, stamping, additive manufacturing, etc.), and further, referring now briefly to FIG. 12, in other exemplary embodiments, one or more of the plurality of airflow nozzles 206 may not extend through the opening 188 of the inner wall 52 of the outer nacelle 50. Moreover, in still other exemplary embodiments, one or more of the plurality of airflow nozzles 206 may be flush with the opening 188 defined in the inner wall 52 the outer nacelle 50, or alternatively, the turbofan engine 10, and more specifically, the airflow delivery system 186, may not include airflow nozzles 206 altogether.

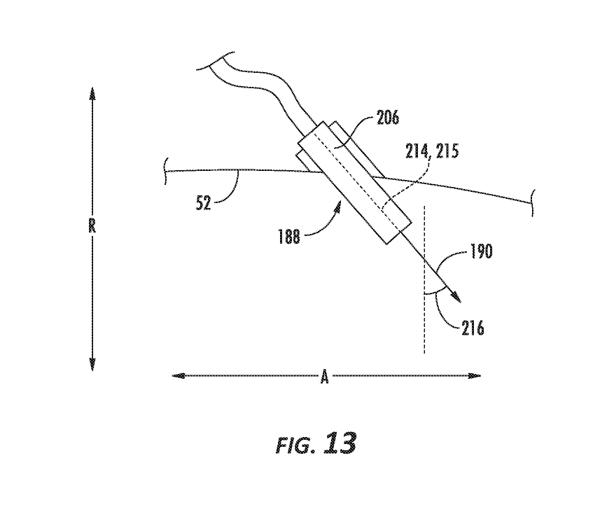

Notably, for the exemplary turbofan engine 10 described above with reference to, e.g., FIGS. 7 and 9, the airflow delivery system 186 is configured to provide the swirl airflow 190 generally in a direction aligned with a reference plane defined by the radial direction R and circumferential direction C (i.e., the plane depicted in FIG. 9). However, in other exemplary embodiments, the airflow delivery system 186 may instead be configured to provide the swirl airflow 190 at an angle greater than zero with the reference plane defined by the radial direction R and the circumferential direction C. For example, referring now briefly to FIG. 13, providing a cross-sectional view of an airflow nozzle 206 in accordance with another exemplary embodiment of the present disclosure, the airflow delivery system 186 may be configured to provide the swirl airflow 190 at an angle 216 between, e.g., about five degrees and about fifty degrees, such as between about ten degrees and about thirty-five degrees with the reference plane defined by the circumferential direction C of the radial direction R. With these embodiments, the airflow nozzles 206 may be referred to as “swept” airflow nozzles.

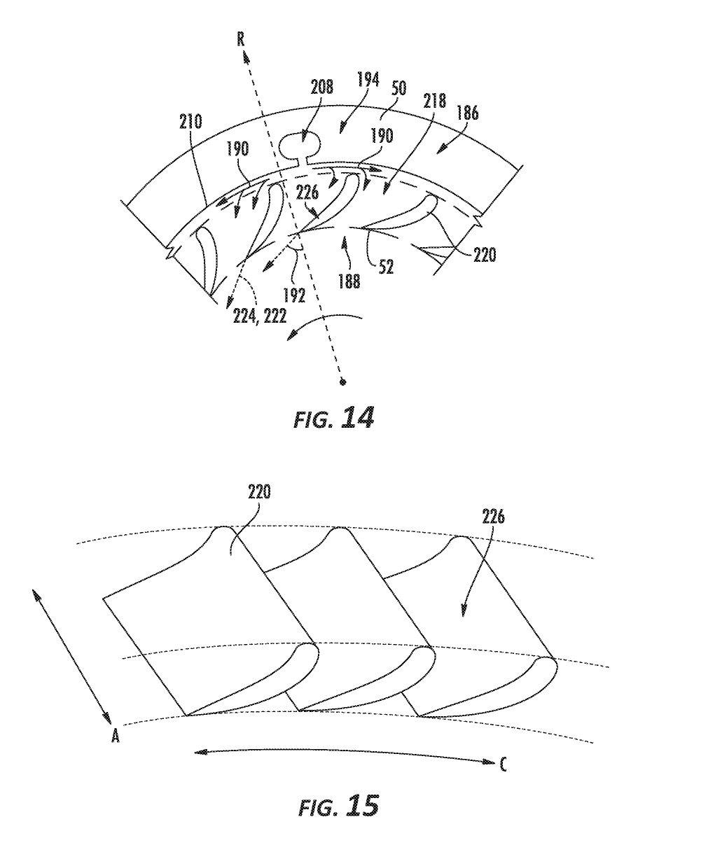

It should be appreciated, however, that in still other exemplary embodiments, the airflow delivery system 186 of the turbofan engine 10 he have any other suitable configuration. For example, referring now also to FIG. 14, a cross-sectional view of a section of an outer nacelle 50 defining openings 188 in accordance with another exemplary embodiment of the present disclosure is provided. The cross-sectional view of FIG. 6 may be the same view provided in FIGS. 21, taking along Line 21-21 of FIG. 7.

Additionally, the embodiment of FIG. 14 may be similar to the exemplary embodiment of FIG. 7, described above. For example, as is depicted, the outer nacelle 50 generally includes an inner wall 52 defining a plurality of openings 188 and the airflow delivery system 186 generally includes an air tube 194. The air tube 194 extends between an inlet 196 and an outlet 198, the outlet 198 being in airflow communication with the plurality of openings 188 and the inlet 196 being in airflow communication with a high pressure air source for receiving the swirl airflow 190 (see FIG. 7). Moreover, as with the exemplary embodiment of FIG. 7, the air tube 194 generally includes a supply air tube 208 and a distribution air tube 210, the distribution air tube 210 extending generally in a circumferential direction C within the outer nacelle 50.

However, for the embodiment of FIG. 14, instead of including a plurality of extension air tube 212 (see FIG. 9), the airflow delivery system 186 includes a plenum 218. The plenum 218 is generally configured as an annular plenum extending circumferentially within the outer nacelle 50 around the openings 188 and between the distribution air tube 210 the inner wall 52 of the outer nacelle 50. Accordingly, for the embodiment depicted, the plenum 218 is defined at least in part by the inner wall 52 of the outer nacelle 50 and the distribution air tube 210, as well as a forward wall and an aft wall (not shown). However, in other exemplary embodiments, the plenum 218 may be defined by any other suitable components of, e.g., the outer nacelle 50 and/or the airflow delivery system 186.

Moreover, for the exemplary embodiment depicted, the airflow distribution system 186 further includes a plurality of swirl features positioned within the plenum 218 for directing the swirl airflow 190 through the plenum 218 to the openings 188. More specifically, referring now also to FIG. 15, providing a perspective view of a portion of the plurality of swirl features of the airflow distribution system 186 of FIG. 14, for the embodiment depicted, each of the plurality of swirl features is configured as an airfoil 220 extending generally between the distribution air tube 210 and the inner wall 52 of the nacelle 50. As will be appreciated, the plurality of airfoils 220 are configured to swirl the airflow 190 provided to the plenum 218 prior to such airflow 190 being provided through the plurality of openings 188 in the inner wall 52 of the nacelle 50.

Further, as is depicted, each of the plurality of airfoils 220 generally defines an airflow direction 222, the airflow direction 222 being the direction in which the swirl airflow 190 is provided through the openings 188 of the inner wall 52. For the embodiment depicted, the airflow direction 222 may be substantially equal to a direction of a reference line 224 defined by a trailing edge of a pressure side 226 of the respective airfoil 220, the reference line 224 being defined by the aft twenty percent of the pressure side 226. More specifically, the reference line 224 is defined by the aft twenty percent of the pressure side 120, as measured along a chord line of the respective airfoil 220. Notably, when the aft twenty percent the pressure side 226 defines a curve, the reference line 224 may be straight-line average fit of such curve (e.g., using least mean squares).

Additionally, for the embodiment depicted the airflow direction 222 (and reference line 224) defines a swirl angle 192. Accordingly, for the embodiment depicted, the swirl angle 192 may refer to an angle between the airflow direction 222 of a respective airfoil 220 and the radial direction R of the turbofan engine 10, or more specifically, for the embodiment depicted, the swirl angle 192 refers to an angle between the airflow direction 222 and a reference plane defined by the radial direction R and the axial direction A of the turbofan engine 10. In certain exemplary embodiments, the swirl angle 192 is between five degrees and thirty-five degrees. For example, in certain embodiments the swirl angle 192 may be between ten degrees and thirty degrees, such as between fifteen degrees and twenty-five degrees.

Further, the airflow distribution system 186 may include any suitable number of airfoils 220 within the plenum 218, such as between about five airfoils 220 and about one hundred airfoils 220. For example, in certain embodiments, airflow distribution system 186 of FIG. 14 may include the same number of airfoils 220 as, e.g., the exemplary turbofan engine 10 described above with reference to FIGS. 1 through 3 includes part span inlet guide vanes 100. For example, in certain exemplary embodiments, the airflow distribution system 186 may include at least twenty airfoils 220, such as at least thirty airfoils 220, and up to about fifty airfoils 220, such as up to about forty-five airfoils 220.

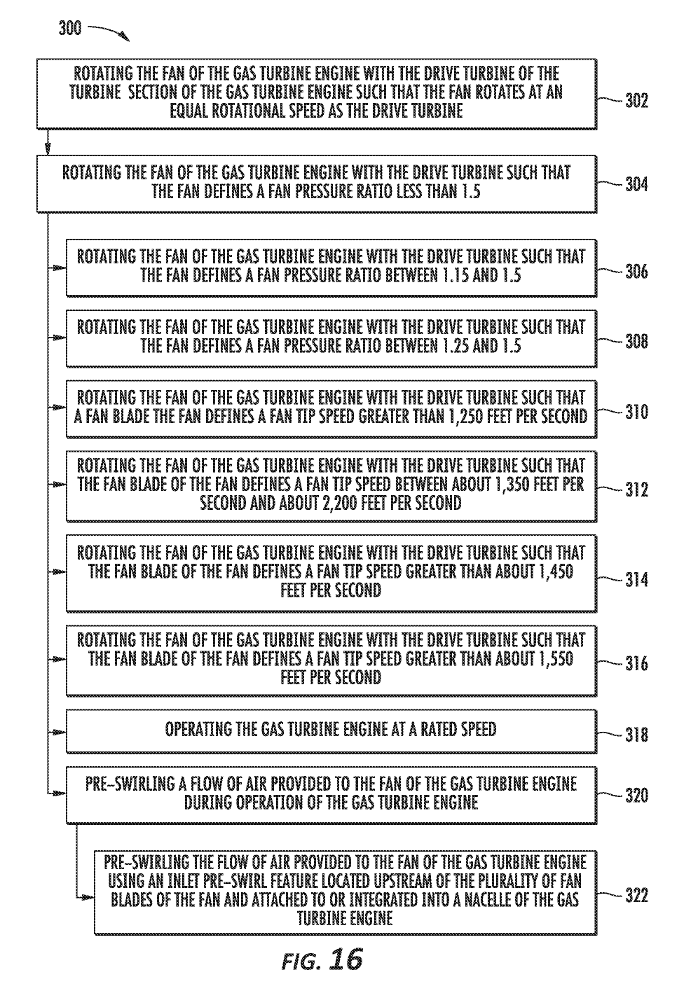

Referring now to FIG. 16, a flow diagram is provided of a method 300 for operating a direct drive gas turbine engine in accordance with an exemplary aspect of the present disclosure. The exemplary direct drive turbofan engine may be configured in accordance with one or more the exemplary gas turbine engines described above with reference to FIGS. 1 through 15. Accordingly, for example, the direct drive gas turbine engine may include a turbine section having a drive turbine and a fan section having a fan driven by the drive turbine.

The exemplary method 300 generally includes at (302) rotating the fan of the gas turbine engine with the drive turbine of the turbine section of the gas turbine engine such that the fan rotates at an equal rotational speed as the drive turbine. Additionally, for the exemplary aspect depicted, rotating the fan of the gas turbine engine with the drive turbine at (302) include at (304) rotating the fan of the gas turbine engine with the drive turbine such that the fan defines a fan pressure ratio less than 1.5. More specifically, for the exemplary aspect depicted, rotating the fan of the gas turbine engine at (304) further includes at (306) rotating the fan of the gas turbine engine with the drive turbine such that the fan defines a fan pressure ratio between 1.5 and 1.5, and further still at (308) rotating the fan of the gas turbine engine with the drive turbine such that the fan defines a fan pressure ratio between 1.25 and 1.5.

Referring still to FIG. 16, rotating the fan of the gas turbine engine with the drive turbine at (304) further includes at (310) rotating the fan of the gas turbine engine with the drive turbine such that a fan blade the fan defines a fan tip speed greater than 1,250 feet per second. More specifically, for the exemplary aspect depicted, rotating the fan of the gas turbine engine with the drive turbine at (304) further includes at (312) rotating the fan of the gas turbine engine with the drive turbine such that the fan blade of the fan defines a fan tip speed between about 1,350 feet per second and about 2,200 feet per second. More specifically, still, for the exemplary aspect depicted, rotating the fan of the gas turbine engine with the drive turbine at (304) further includes at (314) rotating the fan of the gas turbine engine with the drive turbine such that the fan blade of the fan defines a fan tip speed greater than about 1,450 feet per second, and at (316) rotating the fan of the gas turbine engine with the drive turbine such that the fan blade of the fan defines a fan tip speed greater than about 1,550 feet per second.

Further, as is also depicted, for the embodiment FIG. 16, rotating the fan of the gas turbine engine with the drive turbine at (304) includes at (318) operating the gas turbine engine at a rated speed. For example, operating the gas turbine engine at the rated speed at (318) may include operating the gas turbine at a maximum speed to produce a maximum rated power.

Moreover, the exemplary method 300 further includes at (320) pre-swirling a flow of air provided to the fan of the gas turbine engine during operation of the gas turbine engine. For the exemplary aspect depicted, pre-swirling the flow of air at (320) includes at (322) pre-swirling the flow of air provided to the fan of the gas turbine engine using an inlet pre-swirl feature located upstream of the plurality of fan blades of the fan and attached to or integrated into a nacelle of the gas turbine engine. In certain exemplary aspects, the inlet pre-swirl feature may be configured in accordance with one or more of the exemplary inlet pre-swirl features described above with reference to FIGS. 1 through 15. By way of example only, in certain exemplary aspects, pre-swirling the flow of air at (322) may include one or more of the steps (408) through (414) of the exemplary method 400 described below. However, in other embodiments, any other suitable inlet pre-swirl feature and/or method may be utilized.

Operating a direct drive gas turbine engine in accordance with the exemplary aspect described above with reference to FIG. 16 may result in a more efficiently operated gas turbine engine. Further, when the airflow provided to the fan is pre-swirled, such may reduce an amount of separation or shock losses of the airflow with the fan despite the relatively high fan tip speeds at which the fan is operated.

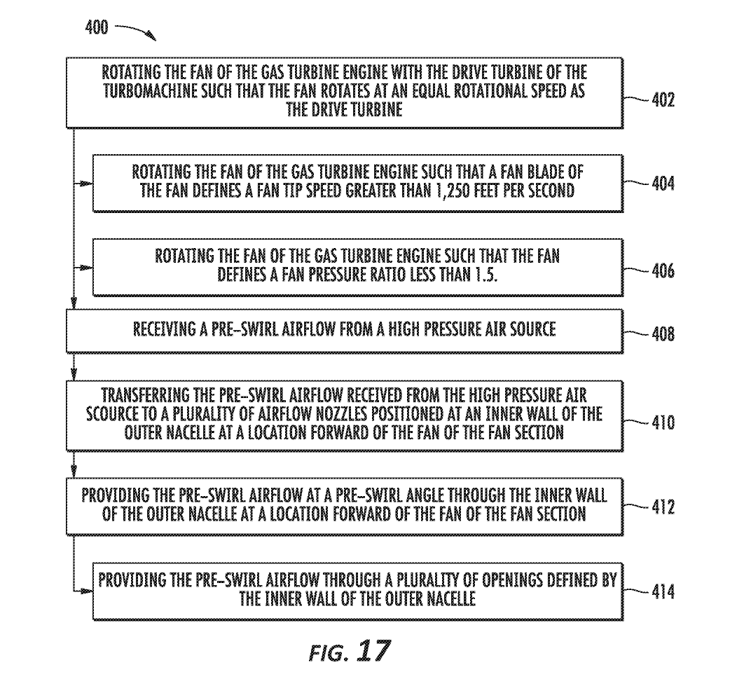

Referring now to FIG. 17, a flow diagram of a method 400 for operating a direct drive gas turbine engine in accordance with another exemplary aspect of the present disclosure is provided. The exemplary method 400 may be utilized with the exemplary gas turbine engines described above with reference to FIGS. 7 through 15. Accordingly, for example, the direct drive gas turbine engine may include a turbomachine, a fan section, and an outer nacelle, with the turbomachine including a drive turbine and the fan section including a fan.

Similar to the exemplary method 300, the exemplary method 400 includes at (402) rotating the fan of the gas turbine engine with the drive turbine of the turbomachine such that the fan rotates at an equal rotational speed as the drive turbine. For the exemplary aspect depicted, rotating the fan with the drive turbine at (402) includes at (404) rotating the fan of the gas turbine engine such that a fan blade of the fan defines a fan tip speed greater than 1,250 feet per second. Additionally, rotating the fan of the drive turbine at (402) further includes, for the exemplary aspect depicted, at (406) rotating the fan of the gas turbine engine such that the fan defines a fan pressure ratio less than 1.5.

Referring still to FIG. 17, the method further includes at (408) receiving a pre-swirl airflow from a high pressure air source and at (410) transferring the pre-swirl airflow received from the high pressure air source to a plurality of airflow nozzles positioned at an inner wall of the outer nacelle at a location forward of the fan of the fan section. In certain exemplary aspects, the high pressure air source may be, e.g., a bypass airflow passage of the direct drive gas turbine engine, or a compressor section of the direct drive gas turbine engine. Additionally, transferring the pre-swirl airflow at (410) may include, e.g., transferring the pre-swirl airflow through one or more air tubes or ducts defined within the direct drive gas turbine engine.

Further, the exemplary method 400 includes at (412) providing the pre-swirl airflow at a pre-swirl angle through the inner wall of the outer nacelle at a location forward of the fan of the fan section. For the exemplary aspect depicted, providing the pre-swirl airflow at the pre-swirl angle through the inner wall of the outer nacelle at (412) includes at (414) providing the pre-swirl airflow through a plurality of openings defined by the inner wall of the outer nacelle. More specifically, for the exemplary aspect depicted, providing the pre-swirl airflow through the plurality of openings defined by the inner wall of the outer nacelle at (414) includes providing the pre-swirl airflow through the plurality of airflow nozzles, each of the plurality of airflow nozzles positioned at, or in airflow communication with, a respective opening defined by the inner wall of the outer nacelle at a location forward of the fan of the fan section. It should be appreciated, however, that in other exemplary aspects, the gas turbine engine may not include the airflow nozzles, and instead may include any other suitable structure for providing the pre-swirl airflow through the plurality of openings at the pre-swirl angle at (414).

Further, for the exemplary aspect depicted, the pre-swirl angle at which the pre-swirl airflow is provided through the inner wall of the outer nacelle is between about five degrees and about thirty-five degrees. Additionally, the pre-swirl angle may be defined relative to, e.g., a radial direction of the direct drive gas turbine engine, or more specifically, relative to a plane defined by the radial direction and an axial direction of the gas turbine engine.

Operating a direct drive gas turbine engine in accordance with the exemplary aspect described above with reference to FIG. 17 may result in a more efficiently operated gas turbine engine. Further, when the airflow provided to the fan is pre-swirled, such may reduce an amount of separation or shock losses of the airflow with the fan despite the relatively high fan tip speeds at which the fan is operated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine engine defining an axial direction and a radial direction, the gas turbine engine comprising:
a turbomachine;
a fan rotatable by the turbomachine, the fan comprising a plurality of fan blades; and
an outer nacelle surrounding the plurality of fan blades and defining an nacelle inlet, the outer nacelle comprising an inner wall defining a plurality of openings located aft of the nacelle inlet and forward of the plurality of fan blades of the fan along the axial direction for providing a swirl airflow upstream of the plurality of fan blades of the fan at a swirl angle greater than zero relative to the radial direction.

2. The gas turbine engine of claim 1, further comprising:
an air tube extending between an inlet and an outlet, wherein the outlet of the air tube is in airflow communication with one or more of the openings defined by the inner wall of the outer nacelle.

3. The gas turbine engine of claim 2, wherein the inlet of the air tube is in airflow communication with a high pressure air source.

4. The gas turbine engine of claim 2, further comprising:
an air compressor, wherein the air compressor is an airflow communication with the air tube.

5. The gas turbine engine of claim 1, further comprising:
a plurality of airflow nozzles, each airflow nozzle positioned at one of the openings defined by the inner wall of the nacelle.

6. The gas turbine engine of claim 5, wherein the plurality of airflow nozzles are formed separately from the inner wall of the outer nacelle and attached to the inner wall of the outer nacelle.

7. The gas turbine engine of claim 5, wherein each of the plurality of airflow nozzles defines an airflow direction, the airflow direction being equal to the swirl angle.

8. The gas turbine engine of claim 7, wherein the swirl angle is between five degrees and thirty-five degrees.

9. The gas turbine engine of claim 1, wherein the turbomachine comprises a drive turbine, wherein the fan is mechanically coupled to and rotatable with the drive turbine such that the fan is rotatable by the drive turbine at the same rotational speed as the drive turbine.

10. The gas turbine engine of claim 9, wherein the fan defines a fan pressure ratio less than 1.5 and a fan tip speed greater than 1,250 feet per second during operation of the gas turbine engine at a rated speed.

11. The gas turbine engine of claim 1, further comprising:
an airflow delivery system, the airflow delivery system, the outer nacelle, or both defining a plenum extending along a circumferential direction of the gas turbine engine and within the outer nacelle, the plenum providing the swirl airflow to the plurality of openings.

12. The gas turbine engine of claim 11, wherein the airflow delivery system further comprises a plurality of swirl features positioned at least partially within the plenum.

13. The gas turbine engine of claim 12, wherein the plurality of swirl features is a plurality of airfoils.

14. The gas turbine engine of claim 13, wherein the plurality of airfoils each define a reference line at a trailing edge, the reference line defining the swirl angle.

15. A method of operating a direct drive gas turbine engine comprising a turbomachine, a fan section, and an outer nacelle, the turbomachine including a drive turbine, the fan section including a fan, and the outer nacelle defining an inlet, the method comprising:
rotating the fan of the gas turbine engine with the drive turbine of the turbomachine such that the fan rotates at an equal rotational speed as the drive turbine; and
providing a swirl airflow at a swirl angle through an inner wall of the outer nacelle at a location forward of the fan of the fan section to pre-swirl a bulk airflow received through the inlet of the outer nacelle.

16. The method of claim 15, wherein providing the swirl airflow at the swirl angle includes providing the swirl airflow through a plurality of openings defined by the inner wall of the outer nacelle.

17. The method of claim 15, wherein the swirl angle is between about five degrees and about thirty-five degrees relative to a radial direction of the gas turbine engine.

18. The method of claim 15, further comprising:
receiving the swirl airflow from a high pressure air source; and
transferring the swirl airflow received from the high pressure air source to a plurality of airflow nozzles positioned at the inner wall of the outer nacelle at a location forward of the fan of the fan section.

19. The method of claim 15, wherein rotating the fan of the gas turbine engine with the drive turbine comprises rotating the fan of the gas turbine engine such that a fan blade of the fan defines a fan tip speed greater than 1,250 feet per second.

20. The method of claim 15, wherein rotating the fan of the gas turbine engine with the drive turbine comprises rotating the fan of the gas turbine engine such that the fan defines a fan pressure ratio less than 1.5.
